(19) United States
(12) Patent Application Publication
(10) Pub. No.: US 2025/0128685 A1
(43) Pub. Date: Apr. 24, 2025

(54) BRAKE SYSTEM FOR A MOTOR VEHICLE AND A CORRESPONDING METHOD FOR OPERATING A BRAKE SYSTEM

(71) Applicant: Robert Bosch GmbH, Stuttgart (DE)

(72) Inventors: Florian Haag, Ellhofen (DE); Markus Schuster, Helmstadt (DE); Martin Marquart, Ludwigsburg (DE); Nikolas Loeffelmann, Dielheim (DE)

(21) Appl. No.: 18/913,379

(22) Filed: Oct. 11, 2024

(30) Foreign Application Priority Data
Oct. 18, 2023 (DE) 10 2023 210 218.8

(51) Int. Cl. B60T 8/1755; B60T 8/171; B60T 13/66

(52) U.S. Cl. CPC B60T 8/1755; B60T 8/171; B60T 13/662; B60T 2220/04; B60T 2270/402; B60T 2270/404; B60T 2270/413; B60T 2270/82

(57) ABSTRACT

A brake system for a motor vehicle. The brake system includes an actuating apparatus including a brake pedal for detecting an actuation value specified by a driver of the motor vehicle, at least one wheel brake assigned to a wheel of the motor vehicle, and at least one controllable actuator apparatus using which a braking force of the wheel brake can be adjusted. The actuator apparatus is coupled to the actuating apparatus via at least one signal connection in order to adjust the braking force in accordance with an actuation value of the actuating apparatus. It is provided that the signal connection is designed to transmit the actuation value from the actuating apparatus to the actuator apparatus in encrypted form. A method for operating a brake system is also described.

### FIELD

The present invention relates to a brake system for a motor vehicle, having an actuating apparatus, in particular a brake pedal, for detecting an actuation value specifiable by a driver of the motor vehicle, having at least one wheel brake assigned to a wheel of the motor vehicle, and having at least one controllable actuator apparatus, by means of which a braking force of the wheel brake can be adjusted. The actuator apparatus is coupled to the actuating apparatus via at least one signal connection in order to adjust the braking force in accordance with an actuation value of the actuating apparatus. The present invention also relates to a method for operating a brake system for a motor vehicle.

### BACKGROUND INFORMATION

Brake systems that form a so-called “brake-by-wire” brake system for a motor vehicle are described in the related art. An actuation value provided by a brake pedal, which value corresponds, for example, to a pedal deflection of the brake pedal and/or a pedal force acting on the brake pedal, is transmitted to an actuator apparatus of the brake system via an electrical signal connection. By means of the actuator apparatus, a braking force corresponding to the pedal deflection and/or the pedal force is subsequently adjusted at a wheel brake of the motor vehicle.

However, the brake system is not able to recognize whether the actuation value transmitted via the signal connection corresponds to the actual pedal deflection or pedal force present at the brake pedal. In particular, it is not possible to determine whether the actuation value transmitted via the signal connection was actually provided by the brake pedal or whether it was generated by a third-party device or manipulated in some other way. Rather, the signal connection between the brake pedal and the actuator apparatus is openly accessible and can be manipulated in principle. Manipulation of the actuation value is understood to mean in particular targeted modification of the actuation value transmitted via the signal connection. With conventional brake systems, there is neither confidential transmission of the actuation value nor validation of the same. If necessary, a plausibility check is effected, which checks the pedal deflection and/or the pedal force, for example, based on the physical limits of the brake pedal. However, targeted manipulation of the actuation value can neither be reliably recognized nor prevented by a plausibility check.

### SUMMARY

An object of the present invention is to provide a brake system that has advantages over conventional brake systems, in particular makes undesired manipulation of the signal connection of the brake system or the actuation value transmitted via the signal connection more difficult and/or makes it possible to recognize an attempt at such undesired manipulation.

This may be achieved by a brake system having certain features of the present invention. According to the present invention, it is provided that the signal connection is designed to transmit the actuation value from the actuating apparatus to the actuator apparatus in encrypted form.

Advantageous designs with expedient developments of the present invention are disclosed herein. It should be noted that the exemplary embodiments described in the description are not restrictive; rather, any variations of the features disclosed herein can be realized.

In particular, the brake system is a component of the motor vehicle. The motor vehicle preferably comprises a drive device by means of which a drive torque aimed at driving the motor vehicle is provided or can be provided. The motor vehicle also has at least one wheel to which the wheel brake is assigned. By means of the wheel brake, a braking force aimed at slowing down the wheel or the motor vehicle can be provided. Preferably, the motor vehicle has a plurality of wheels, each wheel being assigned a corresponding wheel brake. For example, the motor vehicle comprises at least two wheel axles, each having at least one wheel.

The brake system comprises at least one actuator apparatus for adjusting the braking force of the wheel brake. The actuator apparatus is a component of a hydraulic braking apparatus, for example, by means of which braking pressure is applied to the wheel brake. Alternatively, the actuator apparatus is a component of an electromechanical braking apparatus that applies the braking force to the wheel brake by means of an electric drive and optionally a transmission apparatus.

The brake system also comprises the actuating apparatus, which is designed in particular as a brake pedal. The actuating apparatus is designed to detect a braking request from the driver and provide it in the form of the aforementioned actuation value. The actuation value corresponds in particular to a pedal deflection of the brake pedal and/or a pedal force acting on the brake pedal. The actuation value is thus specified by the driver of the motor vehicle by actuating the actuating apparatus accordingly.

The at least one actuator apparatus is designed to adjust the braking force of the wheel brake in accordance with the actuation value. In this respect, the braking force is adjusted in accordance with the pedal deflection and/or the pedal force. For this purpose, the actuator apparatus is coupled to the actuating apparatus via the at least one signal connection.

Thus, the signal connection serves to transmit the actuation value from the actuating apparatus to the actuator apparatus.

The present invention provides that the transmission of the actuation value is effected in encrypted form via the signal connection. In particular, this is to be understood to mean that the actuation value is encrypted by the actuating apparatus using at least one key prior to transmission. Subsequently, the encrypted actuation value is transmitted to the actuator apparatus via the signal connection and decrypted by the actuator apparatus. Encryption is preferably effected by the actuating apparatus, while decryption is preferably effected by the actuator apparatus. Since targeted modification of the encrypted actuation value without knowing the key used is not possible, this procedure makes such manipulation more difficult or makes it possible to recognize attempted manipulation.

A development of the present invention provides that the signal connection is a serial bus system, in particular a CAN bus, of the motor vehicle. Since modern motor vehicles usually have a large number of control devices, they usually comprise at least one central bus system. The bus system is preferably a component of the motor vehicle and is used, for example, for communication between a plurality of control devices of the motor vehicle. One such bus system is a “controller area network” (CAN).

It is provided that the signal connection between the actuating apparatus and the actuator apparatus is preferably effected via the bus system of the motor vehicle. The bus system allows for the encrypted transmission of the actuation value. For example, a CAN bus can be used for encrypted transmission using the Advanced Encryption Standard (AES).

According to an example embodiment of the present invention, the actuating apparatus preferably comprises a control device that is designed to encrypt the actuation value in accordance with the encryption standard used. The key used for encryption is provided by the control device and is, for example, set at the factory. The encrypted actuation value is transmitted to the actuator apparatus via the signal connection or the bus system. The actuator apparatus subsequently decrypts the actuation value. For example, the key used for encryption is also stored in the actuator apparatus at the factory. The actuating apparatus and the actuator apparatus are thus configured at the factory for symmetric encryption of the actuation value. This allows for a particularly easy realization of the encrypted transmission.

Additionally or alternatively, according to an example embodiment of the present invention, an exchange of the key between the actuating apparatus and the actuator apparatus is provided by means of a higher-level asymmetric key exchange procedure. For example, the key is randomly selected when the brake system is started and exchanged between the actuating apparatus and the actuator apparatus by means of the key exchange procedure. Subsequently, the symmetric encryption described above is effected using the randomly selected key. When the brake system is subsequently started, a new key can be selected at random. This improves the security of the encryption, since targeted manipulation with knowledge of the key set at the factory is also recognized or made more difficult.

In order to prevent manipulation of the signal connection through a so-called “replay” attack, with which the actuation value transmitted in encrypted form is intercepted and a manipulated actuation value is later replayed based on the intercepted encrypted actuation value, the use of a random value can be provided. The random value is randomly selected by the control device of the actuator apparatus when the brake system is started and transmitted to the actuator apparatus via the signal connection. Subsequently, the random value is periodically appended to the actuation value, in particular each time it is transmitted, so that a modified encrypted operation value is always transmitted even if a constant operation value is transmitted. When the brake system is subsequently restarted, the random value is randomly selected again, so that such a modification of the encrypted operation value is guaranteed across a restart of the brake system. The “replay” attack described above is thus prevented or at least made more difficult.

A development of the present invention provides that the actuator apparatus is additionally coupled to the actuating apparatus via at least one further signal connection, the further signal connection being designed to transmit the actuation value in unencrypted form to the actuator apparatus.

The further signal connection is present in addition to the signal connection. In particular, the further signal connection is not effected via the serial bus system, but is separate from it.

It is thus provided to transmit the actuation value to the actuator apparatus both in encrypted form via the signal connection and in unencrypted form via the further signal connection. If there is a plurality of actuator apparatuses, it can be provided that the actuation value is transmitted to all actuator apparatuses via a common bus system, with there preferably being, however, at least one further signal connection for each of the actuator apparatuses, via which further signal connection the actuation value is also transmitted to the relevant actuator apparatus in unencrypted form. Alternatively, it can of course also be provided to transmit the actuation value to a plurality or all of the actuator apparatuses via a common further signal connection. Based on the further signal connection, it is ensured that the actuation value used for adjusting the braking force is provided to the actuator apparatuses even if the encrypted transmission via the signal connection is not effected without errors or is effected only with a time delay, for example due to a fault and/or an overload of the bus system.

A development of the present invention provides that the further signal connection is a serial interface and/or a pulse width modulation. As explained above, the further signal connection is separate from the signal connection, in particular from the bus system. The further signal connection is, for example, a serial interface, in particular a serial point-to-point interface, via which the actuation value is transmitted directly and in unencrypted form from the actuating apparatus to the actuator apparatus. Alternatively, the further signal connection is a clocked electrical signal via which the actuation value is transmitted in unencrypted form, for example by means of pulse width modulation. The use of the serial interface or pulse width modulation allows for a particularly simple realization of the further signal connection.

A development of the present invention provides that the at least one actuator apparatus comprises a brake booster and/or a control device for an electronic stability control system. The actuator apparatus is a component of the wheel brake, for example, but can also be separate from it. The actuation value specified by the driver by means of the actuating apparatus is transmitted by the latter to the actuator apparatus via the signal connection. The actuator apparatus comprises the brake booster, by means of which the braking force of the wheel brake is adjusted in accordance with the actuation value.

According to an example embodiment of the present invention, additionally or alternatively, the actuator apparatus comprises the control device for the electronic stability control system, which is designed to adjust the braking force in accordance with the actuation value, with, for example, locking of the wheel being prevented and/or longitudinal stabilization of the motor vehicle being effected. Since the actuation value is transmitted in encrypted form via the signal connection, it is ensured that the actuation value corresponding to the driver's actual braking request is provided to the brake booster or the control device for the electronic stability control system.

The present invention also relates to a method for operating a brake system for a motor vehicle, in particular a brake system in accordance with the embodiments in the context of this description, having an actuating apparatus, in particular a brake pedal, for detecting an actuation value specified by a driver of the motor vehicle, having at least one wheel brake assigned to a wheel of the motor vehicle and having at least one controllable actuator apparatus, by means of which a braking force is adjusted in accordance with the actuation value transmitted to the actuator apparatus by the actuating apparatus via at least one signal connection. It is provided that the actuation value is transmitted to the actuator apparatus in encrypted form via the signal connection.

The present invention also relates to a motor vehicle having a brake system, in particular a brake system in accordance with the embodiments in the context of this description.

Reference has already been made to the advantages of such a design of the brake system, the motor vehicle and a corresponding procedure. The brake system and the motor vehicle as well as the method for the operation thereof can be developed in accordance with the embodiments in the context of this description, so that reference is made to them in this respect.

A development of the present invention provides that the actuation value is additionally transmitted in unencrypted form from the actuating apparatus to the actuator apparatus via at least one further signal connection, and the braking force is adjusted primarily in accordance with the actuation value transmitted in unencrypted form. Reference has already been made above to the further signal connection and the unencrypted transmission of the actuation value.

Thus, the actuation value is transmitted to the actuator apparatus in encrypted form via the signal connection on the one hand and in unencrypted form via the further signal connection on the other hand. Due to the encryption of the actuation value for transmission via the signal connection, said value is available with a time delay with respect to the actuation value transmitted in unencrypted form. This is particularly the case if the signal connection is effected via the bus system.

According to an example embodiment of the present invention, it is now provided to adjust the braking force primarily in accordance with the actuation value transmitted in unencrypted form. This makes it possible to adjust the braking force with as little delay as possible in accordance with the actuation value transmitted in unencrypted form. The actuation value transmitted in encrypted form is used only for recognizing manipulation of the transmitted actuation value. This provides a particularly fast-acting and safe brake system.

A development of the present invention provides that the actuation value transmitted in unencrypted form is validated by a comparison with the actuation value transmitted in encrypted form. Since the further signal connection transmits the actuation value only in unencrypted form, in principle the actuation value transmitted via the further signal connection can be manipulated. In order to recognize this, a comparison with the actuation value transmitted in encrypted form is provided.

Based on the comparison, validation of the actuation value transmitted in unencrypted form is effected. The actuation value transmitted in encrypted form and the actuation value transmitted in unencrypted form should, as long no error or manipulation has occurred, in principle correspond to one another. This makes it possible to validate the actuation value transmitted in unencrypted form by comparing it with the actuation value transmitted in encrypted form. This makes it particularly easy to recognize manipulation or an error.

A development of the present invention provides that, for validating the actuation value transmitted in unencrypted form, a deviation of the actuation value transmitted in unencrypted form from the actuation value transmitted in encrypted form is ascertained, it being concluded that manipulation has occurred if the deviation is greater than a threshold value. As discussed above, the actuation value transmitted in unencrypted form and the actuation value transmitted in encrypted form should in principle correspond to one another.

In order to recognize manipulation, the deviation is ascertained, which is formed, for example, from a difference between the actuation value transmitted in unencrypted form and the actuation value transmitted in encrypted form. A suitable threshold value is set for the deviation, which takes into account, for example, signal noise of the signal connections. It can thus be concluded that manipulation has occurred if the deviation is greater than the threshold value or exceeds it. This makes it as easy as possible to validate the actuation value transmitted in unencrypted form.

A development of the present invention provides that a latency time of the signal connection and/or the further signal connection is taken into account when ascertaining the deviation. Both the signal connection and the further signal connection can have a non-zero latency time. Latency time is understood to mean a time delay with which the actuation value detected by the actuating apparatus is transmitted to the actuator apparatus. The latency time of the signal connection can be different from the latency time of the further signal connection. In particular, the latency time of the signal connection is greater than the latency time of the further signal connection, since the actuation value must be encrypted prior to transmission via the signal connection and decrypted after transmission, whereas these steps are not required for transmission by the further signal connection. If the signal connection is in the form of the bus system, the latency time of the signal connection can in principle be greater than the latency time of the further signal connection.

According to an example embodiment of the present invention, when validating the actuation value transmitted in unencrypted form by comparing it with the actuation value transmitted in encrypted form, a non-zero deviation can thus occur due to the different latency times. In order to prevent this deviation from being falsely recognized as manipulation, the latency time is taken into account when ascertaining the deviation. The latency time can be ascertained, for example, by transmitting a set test value from the actuating apparatus to the actuator apparatus simultaneously via both the signal connection and the further signal connection. Due to the different latency times, the test value is provided to the actuator apparatus with a corresponding time delay. This makes it possible to determine the latency time, or more precisely a difference between the latency time of the signal connection and the further signal connection, at the actuator apparatus. The latency time or difference ascertained in this way is subsequently taken into account when validating the actuation value transmitted in unencrypted form. This procedure prevents the latency time from being falsely recognized as manipulation.

A development of the present invention provides that, if manipulation has occurred, the braking force is adjusted primarily in accordance with the actuation value transmitted in encrypted form, and/or the motor vehicle is decelerated by means of the wheel brake, in particular until the motor vehicle comes to a standstill. If manipulation has occurred, the braking force is thus no longer adjusted in accordance with the actuation value transmitted in unencrypted form. Instead, the actuation value transmitted in unencrypted form is preferably discarded and the braking force is adjusted primarily, in particular exclusively, in accordance with the actuation value transmitted in encrypted form. This ensures that the braking force is adjusted exclusively in accordance with the actuation value specified by the driver of the motor vehicle.

Additionally or alternatively, according to an example embodiment of the present invention, it is provided to adjust the braking force of the wheel brake in such a way that the motor vehicle is decelerated. Preferably, the motor vehicle is decelerated to a standstill. When the motor vehicle comes to a standstill, the braking force is preferably adjusted for holding the motor vehicle at a standstill. This provides a particularly safe motor vehicle.

The features and combinations of features described in the description herein, in particular the features and combinations of features described in the following description of the FIGURES and/or shown in the FIGURES, can be used not only in the combination indicated in each case, but also in other combinations or on their own, without departing from the scope of the present invention. Thus, embodiments that are not explicitly shown or explained in the description and/or the FIGURES, but which result from or can be derived from the explained embodiments by means of combinations of features, are also to be regarded as being covered by the present invention.

The present invention is explained in more detail below with reference to the exemplary embodiment shown in the FIGURE.

### BRIEF DESCRIPTION OF THE DRAWING

FIG. 1 is a schematic representation of a brake system according to an example embodiment of the present invention for a motor vehicle.

### DETAILED DESCRIPTION OF EXAMPLE EMBODIMENTS

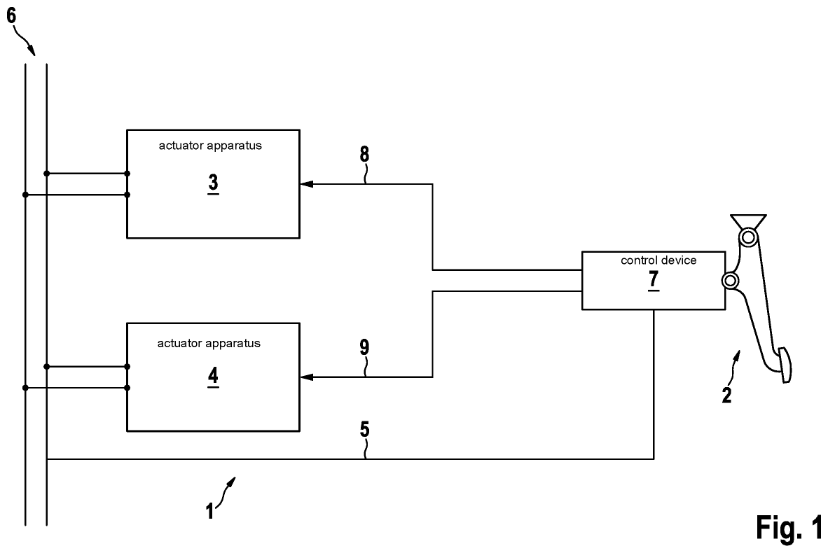

FIG. 1 is a schematic representation of the brake system 1 according to the present invention of a motor vehicle, which is not shown in detail. The brake system 1 includes an actuating apparatus 2 in the form of a brake pedal. The actuating apparatus 2 is operated at least temporarily by a driver of the motor vehicle. For example, the driver applies a pedal force to the actuating apparatus 2, which causes a corresponding pedal deflection. The actuating apparatus 2 is designed to detect the pedal deflection and/or the pedal force and provide it in the form of an actuation value. In this respect, the actuation value corresponds to a braking request specified by the driver of the motor vehicle.

In the exemplary embodiment shown, the brake system 1 has two actuator apparatuses 3 and 4. The first actuator apparatus 3 is a component of a brake booster, for example, while the second actuator apparatus 4 is a component of an electronic stability control system. Both the first actuator apparatus 3 and the second actuator apparatus 4 are designed to adjust a braking force of a wheel brake of the motor vehicle, which wheel brake is not shown in detail.

The two actuator apparatuses 3 and 4 can be controlled for adjusting the braking force. For this purpose, they are coupled to the actuating apparatus 2 via at least one signal connection 5. The signal connection 5 is designed to transmit the actuation value from the actuating apparatus 2 in encrypted form to the two actuator apparatuses 3 and 4. The signal connection 5 is a component of a serial bus system 6, for example a CAN bus, or the signal connection 5 is connected thereto.

The encrypted transmission is effected by means of a symmetric encryption method, in particular by means of an encryption according to the AES standard. In order to allow the encrypted transmission of the actuation value via the signal connection 5, the actuating apparatus 2 has a control device 7. In particular, the control device 7 holds a key available, by means of which the actuation value is encrypted and transmitted via the signal connection 5.

The actuator apparatuses 3 and 4 are designed to decrypt the actuation value transmitted in encrypted form via the signal connection 5. For this purpose, the key used for encryption is available in the actuator apparatuses 3 and 4. In this respect, the same symmetric key is stored both in the control device 7 of the actuating apparatus 2 and in the actuator apparatuses 3 and 4.

The key is set at the factory, for example. Additionally or alternatively, a higher-level key exchange procedure, in particular an asymmetric key exchange procedure, is provided. The key exchange procedure is used in particular to exchange a randomly selected key between the actuating apparatus 2 and the two actuator apparatuses 3 and 4.

In addition to the signal connection 5, which is used for the encrypted transmission of the actuation value, the actuator apparatuses 3 and 4 are each coupled to the actuating apparatus 2 via at least one further signal connection 8 and 9, respectively. The further signal connections 8 and 9 are in the form of a serial interface and/or pulse width modulation, for example.

By means of the further signal connections 8 and 9, the actuation value is transmitted to the actuator apparatuses 3 and 4 in unencrypted form. Thus, the actuation value is transmitted in encrypted form via the signal connection 5 on the one hand and in unencrypted form via the further signal connections 8 and 9 on the other hand. It is provided to adjust the braking force on the wheel brake primarily in accordance with the actuation value transmitted in unencrypted form, since this is transmitted with a shorter time delay due to the latency time of the bus system 6.

The actuation value transmitted in unencrypted form is validated by comparing it with the actuation value transmitted in encrypted form. For example, a deviation of the actuation value transmitted in unencrypted form from the actuation value transmitted in encrypted form is ascertained for this purpose, the latency time of the bus system 6 being taken into account. Based on a comparison of the deviation with a threshold value, it is possible to conclude that manipulation has occurred, for example if the deviation is greater than a set threshold value.

If it is concluded that manipulation has occurred, the braking force is primarily adjusted according to the actuation value transmitted in encrypted form. Additionally or alternatively, it is provided to decelerate the motor vehicle by means of the wheel brake, in particular until the motor vehicle comes to a standstill. Subsequently, further movement of the motor vehicle can be prevented, for example by holding the motor vehicle at a standstill by means of the wheel brake.

1-11. (canceled)

12. A brake system for a motor vehicle, comprising:
an actuating apparatus, including a brake pedal, configured to detect an actuation value specified by a driver of the motor vehicle;
at least one wheel brake assigned to a wheel of the motor vehicle; and
at least one controllable actuator apparatus via which a braking force of the wheel brake can be adjusted, the actuator apparatus being coupled to the actuating apparatus via at least one signal connection in order to adjust the braking force in accordance with an actuation value of the actuating apparatus, wherein the signal connection is configured to transmit the actuation value from the actuating apparatus to the actuator apparatus in encrypted form.

13. The brake system according to claim 12, wherein the signal connection is a serial bus system including a CAN bus of the motor vehicle.

14. The brake system according to claim 12, wherein the actuator apparatus is additionally coupled to the actuating apparatus via at least one further signal connection, the further signal connection being configured to transmit the actuation value from the actuating apparatus to the actuator apparatus in unencrypted form.

15. The brake system according to claim 12, wherein the further signal connection is a serial interface and/or a pulse width modulation.

16. The brake system according to claim 12, wherein the at least one actuator apparatus includes a brake booster and/or a control device for an electronic stability control system.

17. A method for operating a brake system for a motor vehicle, the brake system having an actuating apparatus including a brake pedal configured to detect an actuation value specified by a driver of the motor vehicle, at least one wheel brake assigned to a wheel of the motor vehicle, and at least one controllable actuator apparatus via which a braking force of the wheel brake can be adjusted, the braking force being adjusted in accordance with the actuation value transmitted by the actuating apparatus via at least one signal connection to the actuator apparatus, the method comprising:
transmitting the actuation value in encrypted form via the signal connection to the actuator apparatus.

18. The method according to claim 17, wherein the actuation value is additionally transmitted in unencrypted form from the actuating apparatus to the actuator apparatus via at least one further signal connection, and the braking force is adjusted primarily in accordance with the actuation value transmitted in unencrypted form.

19. The method according to claim 18, wherein the actuation value transmitted in unencrypted form is validated by a comparison with the actuation value transmitted in encrypted form.

20. The method according to claim 19, wherein, for validating the actuation value transmitted in unencrypted form, a deviation of the actuation value transmitted in unencrypted form from the actuation value transmitted in encrypted form is ascertained, it being concluded that manipulation has occurred when the deviation is greater than a threshold value.

21. The method according to claim 20, wherein a latency time of the signal connection and/or the further signal connection is taken into account when ascertaining the deviation.

22. The method according to claim 20, wherein when manipulation has occurred, the braking force is adjusted primarily in accordance with the actuation value transmitted in encrypted form, and/or the motor vehicle is decelerated via the wheel brake until the motor vehicle comes to a standstill.
